(19) United States
(12) Patent Application Publication
(10) Pub. No.: US 2010/0146225 A1
(43) Pub. Date: Jun. 10, 2010

(54) ACYCLIC DATA TRANSFER VIA A FIELD BUS COUPLER

(76) Inventors: Georg Biehler, Nürnberg (DE); Hagen Böhme, Burkhardtsdorf (DE); Stefan Dausend, Schwabach (DE); Siegfried Prieler, Tapfheim (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/632,196

(22) Filed: Dec. 7, 2009

(30) Foreign Application Priority Data
Dec. 10, 2008 (EP) 08021475.2

(51) Int. Cl. G06F 13/36; G06F 12/02

(52) U.S. Cl. 711/154; 710/306; 711/E12.002

(57) ABSTRACT

A field bus coupler, a system with a field bus coupler, a transmission method for acyclic data via a field bus coupler and a computer program product are provided. The field bus coupler is configured to transmit acyclic data. The field bus coupler possesses a first and a second network side, each network side possessing an interface for connecting a field bus. On the first network side an output module is provided for receiving an output data record of a first field bus. The data record is mirrored from the first to the second network side and buffered in a memory. The mirrored data record is thus provided via an input module on the second network side to a second field bus as an input data record.

### CROSS REFERENCE TO RELATED APPLICATIONS

This application claims priority of European Patent Office Application No. 08021475.2 EP filed Dec. 10, 2008, which is incorporated by reference herein in its entirety.

### FIELD OF INVENTION

The present invention relates to a field bus coupler, a system with at least one field bus coupler, a method for transmitting acyclic data via a field bus coupler and a computer program product. In particular the present invention relates to a field bus coupler which is configured to allow the transmission of acyclic data.

### BACKGROUND OF INVENTION

In the automation world there are currently field bus couplers for coupling two electrically and logically separated field busses to each other. These field bus couplers are available a very wide diversity of variants. For example Siemens AG manufactures field bus couplers which make it possible to couple the following field busses: PROFIBUS DP-PROFIBUS PA, PROFIBUS DP-PROFIBUS DP, PROFINET IO-PROFINET IO. Thus field bus couplers can also be used for coupling controllers of different manufacturers if these support the corresponding field bus.

Conventional couplers possess two electrically isolated interfaces which are linked by application firmware in the coupler in order in this way to couple to each other field busses connected to the interfaces. In such cases the coupling is carried out using IO data, with the output data of the one side being mirrored to input data of the other side. In other words the coupler application copies data from one network side to the other network side of the coupler. In such cases each higher-ranking control (e.g. CPU) on the field bus exclusively sees its half of the coupler and the data mirroring is undertaken by means of the coupler firmware.

The input data and output data of a field bus coupler are in this case structured depending on the subordinate field bus, for PROFIBUS DP and PA into modules for example, for PROFINET IO into submodules. It is of no relevance in such cases which field busses are coupled to each other, since only the address models have to be transferable into one another. In relation to the maximum IO data able to be used the minimum of the two field bus definitions and the device restrictions then apply.

Although this coupling of field busses elegantly resolves the cyclic transfer of IO data between individual controllers, it does not deal with the transport of events or acyclic data. In addition the model has limits relating to the volumes of data able to be transported which, although it only needs to be sent now and again (so called acyclic data), is however typically far larger than the maximum IO data volume supported by the respective field bus.

To make an acyclic data transfer possible in a PROFINET for example, two options are known from the prior art. PROFINET is the open non-proprietary Industrial Ethernet Standard for production and process automation. PROFINET uses TCP/IP and IT standards and makes possible end-to-end communication from the factory control level through to the field level. PROFINET also makes a seamless integration of all field bus systems possible.

In accordance with a first option, another protocol (e.g. socket-based communication, such as Open User Communication) can be used. For the use of another protocol however communication modules (transceiver modules) must be called and in this case communication does not pass via the coupler. This approach can thus not be used in situations in which field busses must be electrically isolated and/or field busses use different protocols. This is because, from the user's point of view, communication is only possible if two identical field busses are coupled or if a proprietary solution offering routing between different field busses is used from end to end when different field busses are coupled. The latter requires an additional router/switch/hub between systems to be coupled, which leads to higher costs for the user.

In accordance with a second option a so-called mini protocol based on cyclic data can be modeled to make possible a handshake between sender and receiver, with communication taking place via a field bus coupler. However the modeling of a mini protocol requires expensive programming by the user. The user is thus forced to solve the problem himself, which is inconvenient however. This is because the user must program the communication processes, which is very complex. Even if the load on the user were to be reduced by provision of a library of modules, the data underlying the mini protocol would always have to be transported cyclically on the field bus. This means a basic cyclic load which is also present even when larger volumes of data (acyclic data) are only transported very rarely. It is especially problematic that the user must decide in such a case whether on the one hand he is to provide as little data as possible for the mini protocol in order to keep the basic load small or whether he provides as much data as possible for the mini protocol in order to obtain the appropriate performance from the mini protocol.

### SUMMARY OF INVENTION

An object of the invention is to provide a simplified and improved transmission of acyclic data via a field bus coupler.

The object of the invention is achieved with the features of the independent claims. Preferred embodiments of the invention are specified in the dependent claims.

A field bus coupler with a first and a second network side is created by the invention, along with a transmission method via such a field bus coupler, with each network side of the field bus coupler possessing at least one interface for connecting a field bus. This data record is mirrored by the first and the second network side and is buffered in the memory. The mirrored data record can thus be provided via the input module on the second network side to the second field bus as an input data record.

A data record is to be understood as acyclic data which, in addition to the cyclic data which passes through the field bus coupler continuously, must only be transferred now and again from one subnetwork into another. In this case the acyclic data is far more comprehensive in relation to the quantity of data than the cyclic data which often only consists of one single bit. Field busses such as PROFINET IO, PROFIBUS DP/PA, etc. for example already provide a definition for the transport of parameterization data, diagnostic data and user-specific data, with the transport envelope being referred to for short as the data record. The transmission of data records via a field bus coupler is necessary for example if machines in a subnet have to be adapted to new requirements and/or conditions. If for example a new batch is produced, the corresponding parameters only have to be transferred once as a data record which, especially in relation to cyclic data, possesses a considerable volume of data. In other words the present invention expands conventional field bus couplers by an acyclic interface.

In accordance with the invention the fact is exploited that the data record mechanisms can be project planned particularly easily in a field bus coupler. Thus the firmware of a conventional field bus coupler is adapted such that a data record is accepted on a network side by an assigned controller and mirrored on the other network side. There the data record can be retrieved by another controller or sent to this controller respectively. Previously this mirroring was only possible for cyclic data but not for acyclic data. Accordingly the present invention builds on standard mechanisms so that no expensive and complex programming such as that mentioned above in the case of mini protocols for example is necessary. Such a use of standard mechanisms means reliability and less expense.

Because the acyclic data is only transferred as required (event-controlled or on request) and no cyclic basic load is present, the load is relieved on the field bus couplers and on the field busses connected to them. In particular an application protocol based on cyclic data which brings with it a basic cyclic load can be dispensed with. Thus a user does not have to be concerned any longer with whether and how acyclic data will be transported via the field bus.

But even if the coupler now allows mirroring of data records (acyclic data) the maximum size of the supported data records is restricted in accordance with the possible quantity frameworks of the field busses involved at the coupler. Field busses provide specific protocols for data records that are transferred with a command. The data record has field-bus-specific restrictions regarding its length (with PROFIBUS DP e.g. 240 bytes, with PROFINET IO potentially 4 Gbytes). In addition device-specific restrictions can also exist which further restrict the size supported by the field bus coupler.

Thus, in accordance with an embodiment of the present invention the maximum size of a data record to be stored can be set in advance in the field bus, in order on the one hand to avoid a possible malfunction of the field bus coupler and on the other hand to enable the largest possible volumes of data to be transmitted. The definition of the maximum size of the data record to be mirrored can also be implemented by user in a simple manner. To do this in practice only one functional module of the firmware of the field coupler must be called up and adapted, without any programming knowledge being required. However in the definition of the maximum size of the data record to be mirrored it should also be ensured that the memory into which the data record is copied is sufficiently large to be able to buffer a data record of a maximum size.

A further advantage of the present invention lies in the fact that data record transmission in the coupler is independent of the load state of the connected field busses. A data record is output as an output data record of a field bus at the field bus coupler which perfoims the further processes such as mirroring and buffering. In other words a data record is written into a network side of the field bus coupler and this data record is read out from the other network side of the field bus coupler. Whether the connected field busses are overloaded or defective is not decisive for the correct functioning of the field bus coupler. In particular this enables fluctuations of the cycle time (jitter) in the respective field bus to be suppressed during data transfer via the field bus coupler.

Each data record which is to be transferred via the field bus coupler can be assigned a data record number which is used for identification and can possess a specific meaning for a field device connected to the field bus. There are different types of data record number which are defined in the different field bus standards. Many of the data record numbers have a fixed meaning, some are proprietary and some are not accessible for users.

In accordance with an embodiment of the invention the least one output module and the at least one input module are mixed modules for receiving and providing data. Mixed modules have the advantage that data can be read out and written in. In an alternate embodiment to this the field bus coupler comprises at least one output and input module on both network sides. Then for example specific address ranges can be provided for the input or for the output respectively. In such cases a controller connected via a field bus at the field bus coupler only sees the modules of the corresponding network side, with the controller being able to write to the output (sub)module and read from the input (sub)module. If a mixed (sub) module is provided on the network side of the controller, the higher-ranking controller can read from it and write to it.

As mentioned above, the controller only sees the corresponding modules on the network side of the field bus coupler, since the field bus coupler separates the subnetworks coupled to each other electrically and logically from one another. This gives the advantage that errors, viruses or the like cannot pass through the field bus coupler and can therefore not be passed on from one subnetwork into the other.

In accordance with a further embodiment of the invention the at least one memory of the field bus coupler in which the data record of the one network side is mirrored, is an individual memory module which is logically subdivided for data from the first network side and data from the second network side. For example the individual memory module is embodied as a dual-port RAM for which accesses are possible simultaneously from both sides. The simultaneous accesses enable the two separate network sides of the field bus coupler to operate with common data without any mutual restriction in access speed. This is for example of advantage when data records have to be transferred in both directions. As an alternative to this the field bus coupler comprises a first memory for data from the first network side and the second memory for data from the second network side as separate memory modules. An electrical isolation of the memories has the advantage that they are independent of each other and errors, viruses or the like of one memory cannot affect the other. A higher degree of security is achieved in this way. In accordance with an embodiment the logically subdivided memory or the electrically isolated memories can be configured so that they issue an alarm as soon as an error or viruses are detected, so that the field bus coupler can take account of this in its further operating sequence. For example the field bus coupler could then prevent further access to the defective memory and configure another memory or memory area respectively so that it is logically divided up for the data of the two network sides.

In accordance with a preferred embodiment of the present invention the at least one memory of the field bus coupler is embodied as a FIFO buffer. This allows a mirrored data record to remain in the memory long enough for it to be retrieved by a corresponding controller. A subsequent data record is then likewise written into the memory, but without overwriting the data record already located therein. The embodiment of the memory as a FIFO buffer is especially advantageous in cases in which the cycle times on the field busses are different. For example a FIFO buffer makes it possible for data to be written on the one network side at high speed (e.g. 12 Mbits/s) into the field bus coupler and to be read out on the other network side at a far lower speed (e.g. 1.5 Mbit/s). However the FIFO buffer is also of advantage if the subnetwork on the network side of the field bus coupler at which the data record will be mirrored is overloaded. The data record can then remain in the buffer until such time as it is retrieved, with a subsequent data record not overwriting the data record not yet retrieved.

However the at least one memory can also be embodied as an overwrite memory, in which an existing data record which has not yet been retrieved will be overwritten by a new data record. Then a data record will be transferred unbuffered from a network side to the other network side of the field bus coupler. This is possible for example when two identical field busses are coupled to one another which in particular have identical cycle times and it is thus probable that the mirrored data record will be retrieved before a new data record is mirrored.

In accordance with a further aspect of the present invention a system is provided, comprising at least two subnetworks, in which individual components are connected to each other via a field bus, with the field busses of the subnetworks being coupled to one another by at least one field bus coupler, as described above. For example the inventive system is used in vehicle production. In a motor vehicle production line a plurality of welding robots is usually arranged, with one or more of the welding robots forming a robot cell in each case. The individual robot cells form subnetworks and are coupled to each other via field bus couplers. Cyclic data is transferred via these field bus couplers. Such cyclic data usually consists only of individual bits (0 or 1) in order to notify the subsequent robot whether the previous robot has finished or not. By using an inventive field bus coupler, larger volumes of data can now be exchanged in an especially simple manner between devices of the subnetworks, for example new configuration data, by which reaction times can be greatly reduced.

In accordance with a further aspect of the present invention a computer program product is provided, especially a digital memory medium with computer-executable instructions for executing the transmission method for acyclic data via a field bus coupler as described above.

### BRIEF DESCRIPTION OF THE DRAWINGS

Preferred exemplary embodiments of the invention are explained below in greater detail with reference to the drawing.

FIG. 1 shows a system with a field bus coupler in accordance with an exemplary embodiment of the present invention and

FIG. 2 shows a flow diagram of a transmission method for acyclic data over a field bus coupler in accordance with the present invention.

### DETAILED DESCRIPTION OF INVENTION

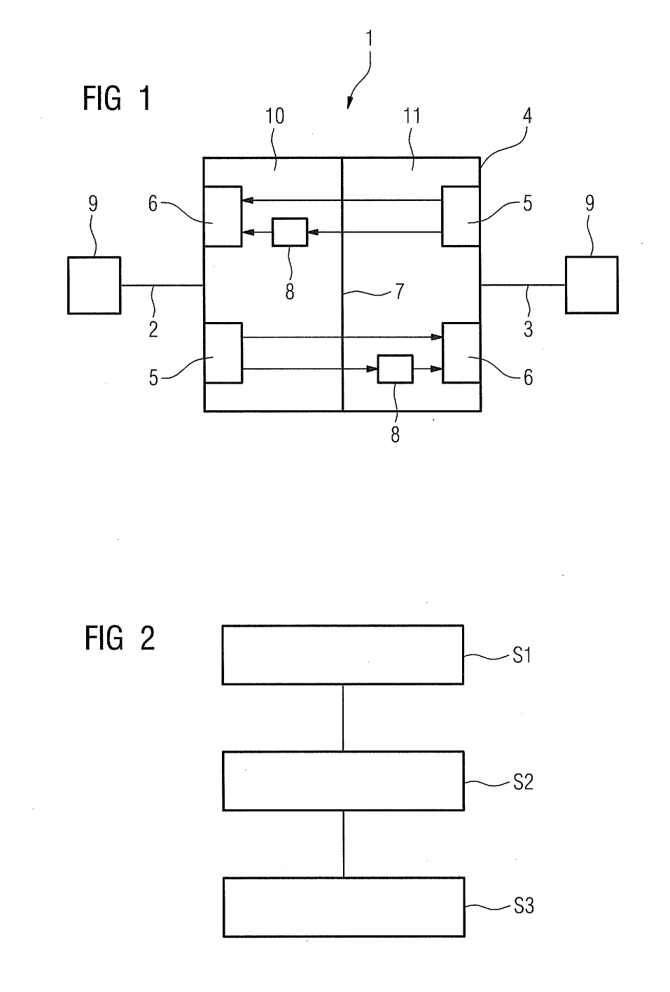

FIG. 1 shows a system 1 which consists of two subnetworks which are coupled to each other via a field bus coupler 4 in accordance with an exemplary embodiment of the present invention. The field bus coupler 4 depicted is a PROFINET(PN)/PROFINET(PN) coupler, with which a non-proprietary deterministic data coupling between two PROFINET networks can be realized quickly and easily. The PN/PN coupler depicted in FIG. 1 thus has as one device two PROFINET interfaces each with an output module 5 and an input module 6, with the interfaces being connected to the corresponding subnetwork.

As indicated graphically by a line 7 in the middle of the field bus coupler 4, the field bus coupler guarantees a secure separation of the two subnetworks coupled to each other. This is also achieved by two IO facilities being made from the one PN/PN coupler at the project planning stage. The other part of the PN/PN coupler in each case is designated the coupling partner. At the conclusion of the project planning the two IO facilities will be joined.

As already described at the outset, the output and input data of the field bus coupler 4 is structured in accordance with the subordinate field bus, in the case of PROFINET into submodules (not shown). Each submodule is provided with a specific address into which a data record will be written or from which a data record will be read out respectively. In the exemplary embodiment shown there is further provision for cyclic data to be mirrored unbuffered from an output module 5 to an input module 6 of the field bus coupler 4. Thus the PN/PN coupler permanently copies cyclic output data of the one subnetwork to the input data of the other subnetwork (and vice versa). In this manner short transfer times can be achieved via the field bus coupler. Acyclic data (data records) by contrast is mirrored from an output module 5 into a memory 8, which is embodied as a FIFO buffer for example, on a network side 10, 11 of the input module 6. Thus linked submodules (not shown) in the field bus coupler 4 of the left and right network side 10, 11 of the field bus coupler 4 transport the data records written into one network side in a FIFO pipe model to the other network side where they are available for retrieval by a higher-ranking controller 9 there. However in many cases it can also the useful to transmit the cyclic data buffered and/or the acyclic data unbuffered.

To inform the higher-ranking controller 9 about a newly arrived data record, different alternatives can be used. For example a user program of the higher-ranking controller 9 can be informed asynchronously via an alarm (e.g. with PROFINET IO Upload&Retrieval) or a user program of the higher-ranking controller 9 can poll information in the user data (e.g. rising edge of a bit). As soon as a data record has been fetched by the higher-ranking controller 9 the resources in the field bus coupler 4 will be released again. Furthermore a release of the resources can also be undertaken if the fetching controller 9 or the feeding controller 9 respectively fails. In this case the opposite side can be correspondingly informed with mechanisms that are known from the prior art (e.g. pulling/plugging alarm with IO data characteristic). To enable the resources of the field bus coupler 4 to be estimated the field bus coupler may reject the writing of data records if its resources are scarce. A threshold value can be predefined this purpose for example, beyond which the resources of the field bus coupler 4 are deemed to be scarce. Since the resources are released on retrieval of the data records on the opposite side, the user can prevent a resource overflow by a corresponding applicative flow control. In addition the acceptance of data records into an input module 6 can be rejected if the opposite side is not set up there.

FIG. 2 shows a flow diagram of a method for transmission of acyclic data via a field bus coupler in accordance with the present invention. In a first step S1 the field bus coupler receives on its first network side an output data record of a first field bus which is connected to the first network side of the field bus coupler. In a second step S2 this data record will be mirrored in a memory of the field bus coupler. Subsequently in a third step S3 the mirrored data record will be provided as an input data record for a second field bus, which is connected to the second network side of the field bus coupler. In this case the memory in which the data record is mirrored can be a FIFO buffer which buffers the mirrored data record until such time as it will be retrieved by the corresponding controller.

1.-9. (canceled)

10. A field bus coupler, comprising:
a first and a second network side, each network side comprising an interface for connecting a field bus;
a first output module on the first network side for receiving an acyclic output data record of a first field bus;
a first input module on the first network side for providing the first field bus with an acyclic input data record;
a second output module on the second network side for receiving an acyclic output data record of a second field bus;
a second input module on the second network side for providing the second field bus with an acyclic input data record;
means for transmitting the acyclic output data record from the first output module on the first network side to the second input module on the second network side;
means of transmitting the acyclic output data record from the second output module on the second network side to the first input module on the first network side; and
a memory for buffering the transmitted data record.

11. The field bus coupler as claimed in claim 10, wherein the output modules and the input modules are mixed modules for receiving and providing data.

12. The field bus coupler as claimed in claim 10, wherein the memory is a single memory chip which is logically subdivided for data from the first network side and data from the second network side.

13. The field bus coupler as claimed in claim 10, wherein the memory comprises
a first memory for data of the first network side; and
a second memory for data of the second network side,
wherein the first and second memory are separate memory chips.

14. The field bus coupler as claimed in claim 11, wherein the memory comprises
a first memory for data of the first network side; and
a second memory for data of the second network side,
wherein the first and second memories are separate memory chips.

15. The field bus coupler as claimed in claim 10, wherein the memory is embodied as a FIFO buffer.

16. The field bus coupler as claimed in claim 13, wherein the memories are embodied as FIFO buffers.

17. The field bus coupler as claimed in claim 14, wherein the memories are embodied as FIFO buffers.

18. A system, comprising:
two subnetworks, in which individual components are connected to each other via a field bus, the field busses of the subnetworks being connected to each other via a field bus coupler, the field bus coupler comprising:
a first and a second network side, each network side comprising an interface for connecting a field bus;
a first output module on the first network side for receiving an acyclic output data record of a first field bus;
a first input module on the first network side for providing the first field bus with an acyclic input data record;
a second output module on the second network side for receiving an acyclic output data record of a second field bus;
a second input module on the second network side for providing the second field bus with an acyclic input data record;
means for transmitting the acyclic output data record from the first output module on the first network side to the second input module on the second network side;
means of transmitting the acyclic output data record from the second output module on the second network side to the first input module on the first network side; and
a memory for buffering the transmitted data record.

19. The system as claimed in claim 18, wherein the output modules and the input modules are mixed modules for receiving and providing data.

20. The system as claimed in claim 18, wherein the memory is a single memory chip which is logically subdivided for data from the first network side and data from the second network side.

21. The system as claimed in claim 18, wherein the memory comprises
a first memory for data of the first network side; and
a second memory for data of the second network side,
wherein the first and second memory are separate memory chips.

22. The system as claimed in claim 19, wherein the memory comprises
a first memory for data of the first network side; and
a second memory for data of the second network side,
wherein the first and second memories are separate memory chips.

23. The system as claimed in claim 18, wherein the memory is embodied as a FIFO buffer.

24. The system as claimed in claim 21, wherein the memories are embodied as FIFO buffers.

25. The system as claimed in claim 22, wherein the memories are embodied as FIFO buffers.

26. A method of transmitting acyclic data via a field bus coupler coupling two field busses to each other, comprising:
receiving an output data record of a first field bus on a first network side of the field bus coupler;
storing the output data record in a memory of the field bus coupler; and
providing the stored output data record as an input data record for a second field bus on a second network side of the field bus coupler.

27. The method as claimed in claim 26, wherein a maximum size of a data record to be transmitted is defined.
